(19) United States
(12) Patent Application Publication
(10) Pub. No.: US 2012/0175830 A1
(43) Pub. Date: Jul. 12, 2012

(54) BUFFER

(76) Inventor: Ching-Chuan YANG, Taipei County (TW)

(21) Appl. No.: 12/986,691

(22) Filed: Jan. 7, 2011

(51) Int. Cl. F16F 11/00; F16F 13/00

(52) U.S. Cl. 267/140.13; 188/271

(57) ABSTRACT

A buffer includes a hollow tube, a first cap located at one end of the tube, a shaft, a flexible valve and a flexible inflation member. The shaft includes a main stem, an action stem and a sub-stem. The main stem and/or sub-stem are extended outside the tube. The main stem and action stem are bridged by a connection bar which has a first detent element connected to the main stem. The action stem has a coupling portion coupled with the connection bar, a stem surface with air intake grooves and a second detent element with notches. The inflation member has two ends surrounding the outer surface of the connection bar and the stem surface of the action stem to form a compression zone with the action stem. The buffer thus formed can prevent buffer delay and enhance buffer damping capability to generate steady and secure buffering effect.

### FIELD OF THE INVENTION

The present invention relates to a buffer for household hardware and particularly to an air pressure buffer.

### BACKGROUND OF THE INVENTION

In early days, pliable rubber pads or elastic springs and reeds are generally adopted to be buffers to avert direct impact of objects to reduce shock and noise. However, as used in houses to cushion impact, such as closing doors against door frames or pushing drawers into cabinets, a buffer usually is employed to reduce closing speed and impact. Applicant has disclosed an air pressure hinge in P.R.C. patent No. CN2685495Y. Refer to FIGS. 3 and 4 in this prior art, it includes an air cylinder and a telescopic cylinder axle with one end exposed outside that has an axle hole formed thereon and a hinge portion run through by a first pivot to be hinged on a butting member. The cylinder shaft has another end coupled with a regulation valve made of plastics or rubber. The regulation valve has an outer wall formed at a greater thickness in the center and thinner at two sides. When the cylinder shaft runs into the air cylinder, the outer wall of the regulation valve moves along the inner wall of the air cylinder and consumes less force. When the cylinder shaft is extended out of the air cylinder, the regulation valve moves reversely along the inner wall of the air cylinder and the thinner portions at two sides of the regulation valve are extended, hence is consumed greater force. As a result, buffer delay frequently takes place when the air cylinder is subject to external forces, and unstable pause conditions could occur during the cylinder shaft is undertaken buffering, thus the prior art provides limited buffering effect and could result in unsecured or inaccurate positioning.

### SUMMARY OF THE INVENTION

The primary object of the present invention is to overcome the aforesaid shortcomings by providing a buffer to prevent buffer delay when external force is applied, enhance damping capability and generate steady buffering effect.

To achieve the foregoing object, the buffer according to the invention includes a hollow tube, a first cap located at one end of the tube, a shaft running through the tube and having a main stem, an action stem and a sub-stem with the main stem and/or sub-stem extended outside the tube. In addition, the main stem and action stem are bridged by a connection bar which has a first detent element connected to the main stem. The action stem includes a coupling portion coupled with the connection bar, and a stem surface with air intake grooves formed thereon and a second detent element with notches formed thereon. The buffer also includes a flexible valve held in the tube and surrounding the action stem in an annular manner. The valve has an outer surface in contact with the inner wall of the tube in a sliding fashion, and an inner surface confined to be slid on the stem surface of the action stem. The valve further has an annular recess at one side to form an open space with the tube and the action stem extended to the sub-stem, and another side facing the first cap. The outer surface of the valve forms a closed space with the tube, action stem and connection bar extended to the main stem and the first cap. The buffer further includes a flexible inflation member held in the closed space and surrounding the coupling portion of the action stem in an annular manner. The inflation member has two ends surrounding the outer surface of the connection bar and the stem surface of the action stem to form a compression zone with the action stem. The inflation element has an outer surface in contact with the inner wall of the tube in a sliding manner, and at least one axial ventilation groove formed on the outer surface thereof.

Compared with the conventional techniques, the structure of the present invention set forth above provides many benefits, notably: 1. the buffer of the invention prevents buffer delay when applied by external forces; 2. the buffer of the invention enhances buffer damping capability and generate steady and secured buffering effect.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is an exploded view of a first embodiment of the invention.

FIG. 2 is a schematic view according to FIG. 1 in an assembled condition.

FIGS. 3A through 3C are sectional views according to FIG. 1 in continuous operating conditions.

FIGS. 4A through 4C are sectional views according to FIG. 1 in continuous operating conditions with a compression spring installed in the closed space.

FIGS. 5A through 5C are sectional views of a second embodiment of the invention in continuous operating conditions.

FIGS. 6A through 6C are sectional views according to FIGS. 5A through 5C in continuous operating conditions with a compression spring installed in the closed space.

FIGS. 7A through 7C are sectional views of a third embodiment of the invention in continuous operating conditions.

FIGS. 8A through 8C are sectional views according to FIGS. 7A through 7C in continuous operating conditions with a compression spring installed in the closed space.

FIGS. 9A and 9B are sectional views of a fourth embodiment of the invention in continuous operating conditions.

FIGS. 10A and 10B are sectional views according to FIGS. 9A and 9B in continuous operating conditions with a compression spring installed in the closed space.

FIGS. 11A and 11B are sectional views of a fifth embodiment of the invention in continuous operating conditions.

### DETAILED DESCRIPTION OF THE PREFERRED EMBODIMENTS

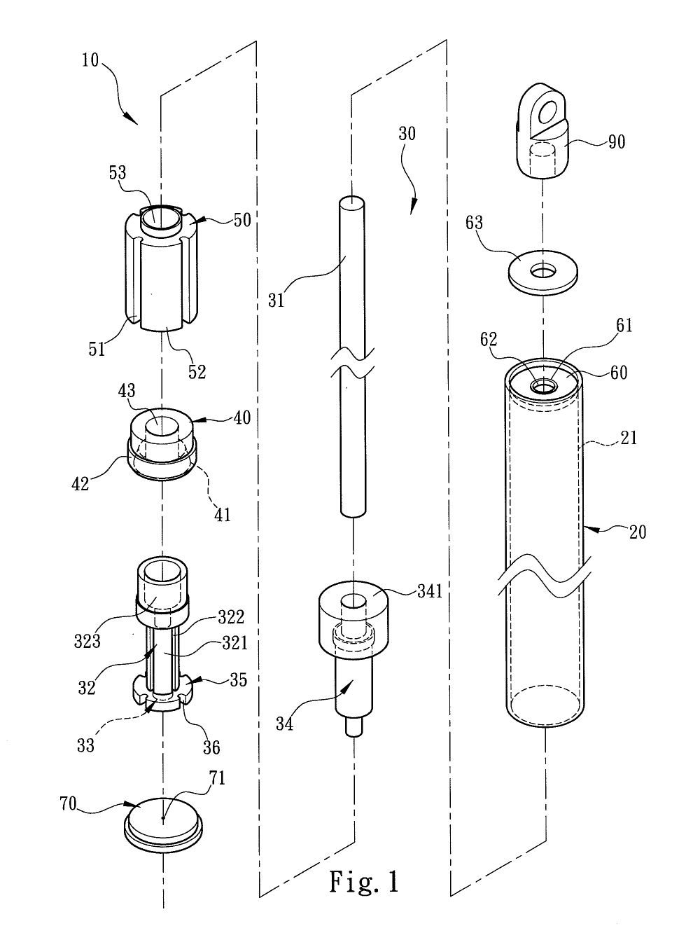

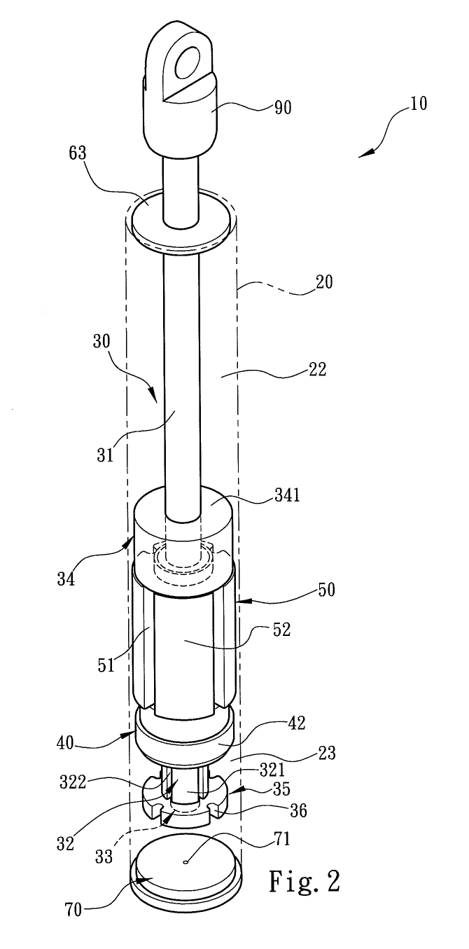

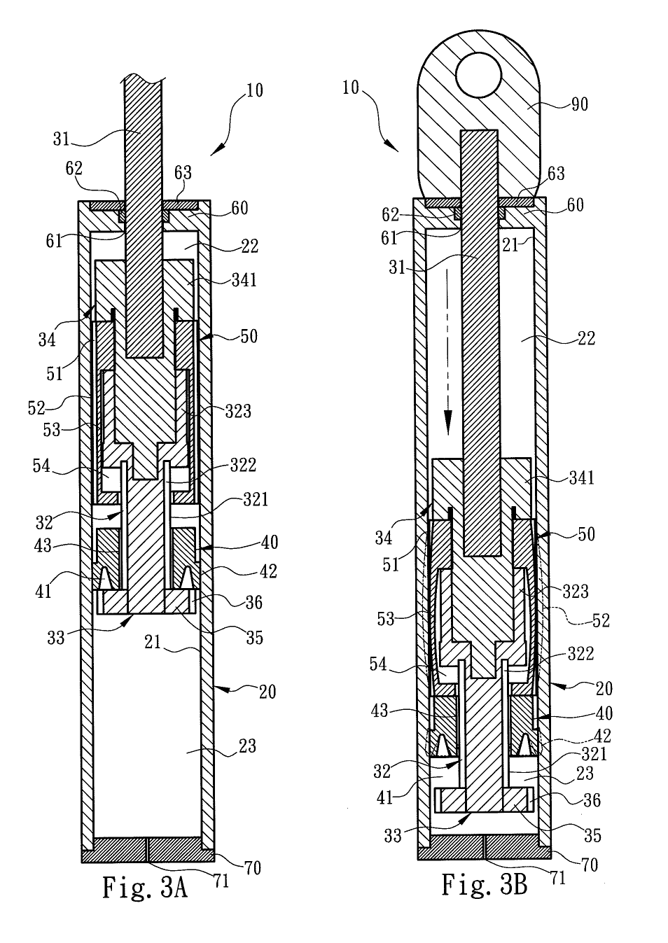

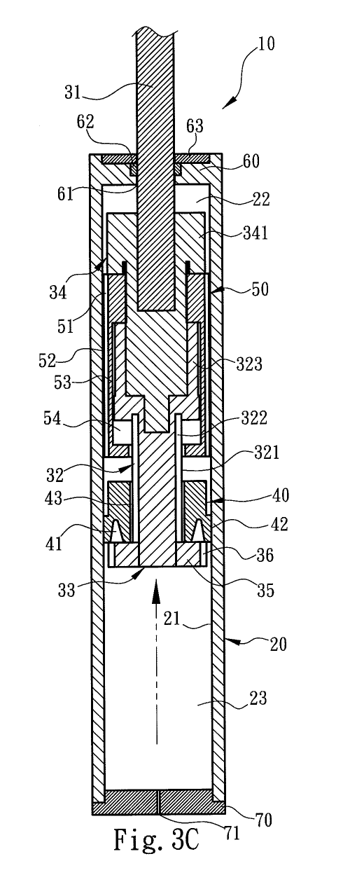

Please refer to FIGS. 1, 2 and 3A through 3C for a first embodiment of the invention. The present invention aims to provide a buffer 10 which includes a hollow tube 20 and a first cap 60 located at one end of the tube 20. The first cap 60 has an opening 61 surrounded by a flexible seal ring 62 made of rubber on the periphery thereof. An annular detent disc 63 may also be provided to cover the seal ring 62 from above. The buffer 10 further has a shaft 30 running through the tube 20 that includes a main stem 31, an action stem 32 and a sub-stem 33. The main stem 31 is extended outside the tube 20. The seal ring 62 is closely coupled with the main stem 31. The main stem 31 has a distal end extended outside the tube 20 to fasten to a connector 90. The main stem 31 and action stem 32 are bridged by a connection bar 34. The main stem 31, connection bar 34, action stem 32 and sub-stem 33 are coupled integrally to form the shaft 30. The connection bar 34 has a first detent element 341 coupled with the main stem 31. The action stem 32 has a coupling portion 323 coupled with the connection bar 34, a stem surface 321 with air intake grooves 322 formed thereon and a second detent element 35 with notches 36 formed thereon. The buffer 10 also includes a flexible valve 40 held in the tube 20 and surrounding the action stem 32 in an annular manner. The valve 40 is formed at an outer diameter slightly greater than the inner diameter of the tube 20 by 0.2 mm. The valve 40 has an outer surface 42 in contact with an inner wall 21 of the tube 20 in a sliding manner. The valve 40 also has an inner diameter slightly greater than the outer diameter of the action stem 32 by 0.2 mm. The valve 40 further has an inner surface 43 confined to be slid on the stem surface 321 of the action stem 32. The valve 40 also has an annular recess 41 at one side to form an open space 23 with the tube 20 and the action stem 32 extended to the sub-stem 33, and another side facing the first cap 60. The outer surface 42 of the valve 40 forms a closed space 22 with the tube 20, action stem 32 and connection bar 34 extended to the main stem 31 and first cap 60. The buffer 10 further has a flexible inflation member 50 held in the closed space 22 and surrounding the coupling portion 323 of action stem 32 in an annular manner. The inflation member 50 is formed at an outer diameter slightly smaller than the inner diameter of the tube 20 by 0.1 mm. The inflation member 50 has two ends annularly surrounding the outer surface of the connection bar 34 and the stem surface 321 of the action stem 32 to form a compression zone 54 with the action stem 32. The inflation member 50 also has an outer surface 52 in contact with the inner wall 21 of the tube 20 in a sliding manner, and at least one axial ventilation groove 51 formed on the outer surface 52 thereof. The tube 20 has another end coupled with a second cap 70 to allow exterior of the tube 20 to be communicated with the open space 23 (namely the second cap 70 keeps the open space 23 open without forming a sealed condition). The second cap 70 may also have a small aperture 71 to allow the exterior of the tube 20 to be communicated with the open space 23 (the size of the aperture 71 affects magnitude of buffering force, thus can be altered as required). The first detent element 341 is formed at an outer diameter smaller than that of the inflation member 50, and greater than or equal to the outer diameter of the main stem 31. The second detent element 35 is formed at an outer diameter smaller than that of the valve 40, and greater than or equal to that of the sub-stem 33. The second detent element 35 has at least one notch 36 to allow the exterior of the tube 20 to be communicated with the recess 41. Also refer to FIGS. 3A through 3C for the first embodiment in continuous operating conditions. When the buffer 10 is in the condition shown in FIG. 3A, the shaft 30 is pushed downwards by an external force; the closed space 22 is enlarged instantly, and the air pressure per unit of area sustained by the lateral side of the valve 40 from the closed space 22 is dropped abruptly; the air pressure in the open space 23 pushes the outer surface 42 of the valve 40 outwards to press the inner wall 21 of the tube 20 to form a tighter condition (with the valve 40 expanded outwards, the outer surface 42 originally should be located at the virtual lines is confined by the inner wall 21 of the tube 20, thus forms tighter coupling with the inner wall 21; the same effect also is applied to all other embodiments discussed below). Meanwhile, the inner surface 43 of the valve 40 is slid on the stem surface 321 and pressed towards the inflation member 50; the air pressure also enters the compression zone 54 through the air intake grooves 322 to expand the inflation member 50 outwards; as the inflation member 50 is confined by the first detent element 341, the inflation member 50 is deformed to squeeze the inner wall 21 of the tube 20 to form an even tighter coupling condition as shown in FIG. 3B (with the inflation member 50 deformed, the outer surface 52 originally should be located at the virtual lines is confined by the inner wall 21 of the tube 20, thus forms tighter coupling with the inner wall 21; the same effect also is applied to all other embodiments discussed below). Thus the valve 40 and the inflation member 50 are used to enhance buffer damping for the downward moving shaft 30 to allow the shaft 30 to move steadily and slowly downwards. Other alternatives may also be adopted to increase the buffer damping capability and effect previously discussed, such as forming a coarse surface on the outer surface 52 of the inflation member 50, or greasing damping oil on the outer surface 52, or increasing the contact area between the outer surface 52 and inner wall 21 of the tube 20. On the other hand, referring to FIG. 3B, when the shaft 30 is moved upwards by a reverse pulling force, the valve 40 and inflation member 50 are quickly returned to their original shapes, the air pressure in the open space 23 pushes the valve 40 upwards to aid the shaft 30 to move upwards as shown in FIG. 3C.

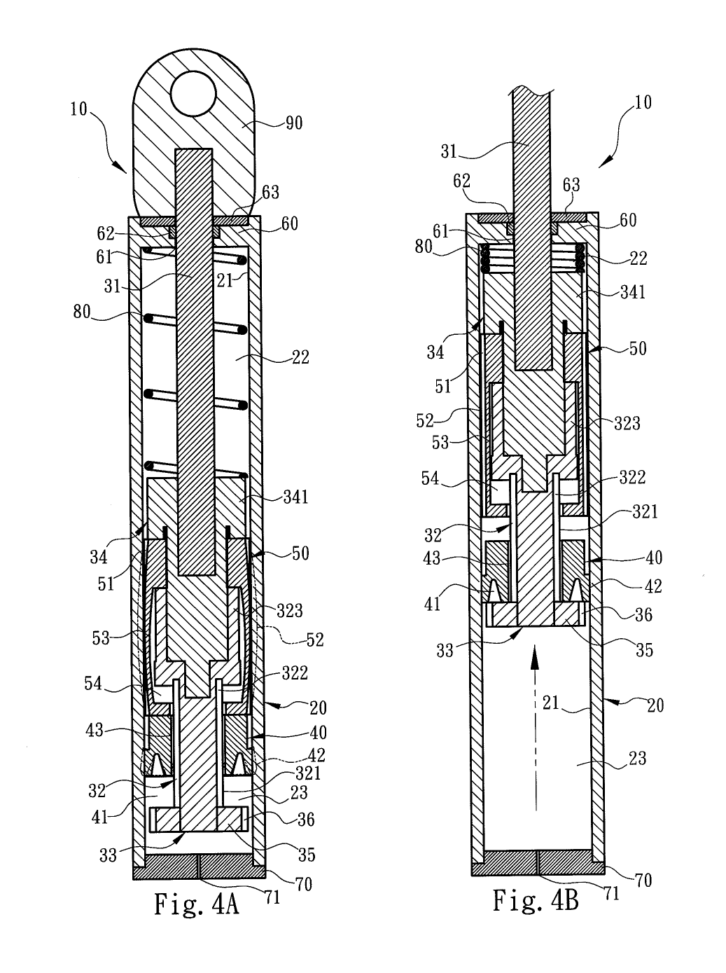

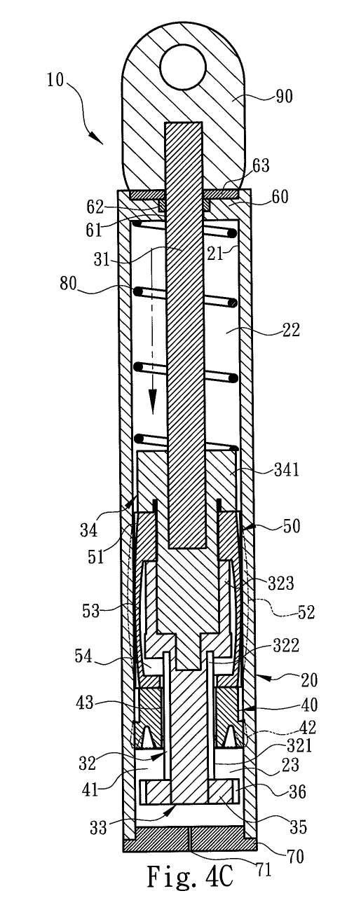

Please refer to FIGS. 4A through 4C for a variation of the first embodiment by adding a compression spring in the closed space 22. A compression spring 80 is installed in the closed space 22 between the first cap 60 and first detent element 341. When the shaft 30 is moved upwards by an external pulling force as shown in FIG. 4A, the pressure of the compression spring 80 is greater than that of the open space 23, hence the upward pulling force has to overcome the pressure of the compression spring 80 to make the valve 40 and inflation member 50 to return quickly to their original shapes as shown in FIG. 4B with the shaft 30 being moved upwards. On the other hand, also referring to FIG. 4B, when the shaft 30 is moved downwards by reverse thrust, the outer surface 42 of the valve 40 is expanded outwards to squeeze the inner wall 21 of the tube 20 to form a tighter coupling, and simultaneously compresses the inflation member 50, the air pressure also enters the compression zone 54 through the air intake grooves 322 to expand the inflation member 50 outwards, and the inflation member 50 is deformed to squeeze the inner wall 21 of the tube 20 to form an even tighter coupling condition as shown in FIG. 4C. Hence the valve 40 and the inflation member 50 are used to increase downward buffer damping for the shaft 30 being moved steadily and slowly downwards.

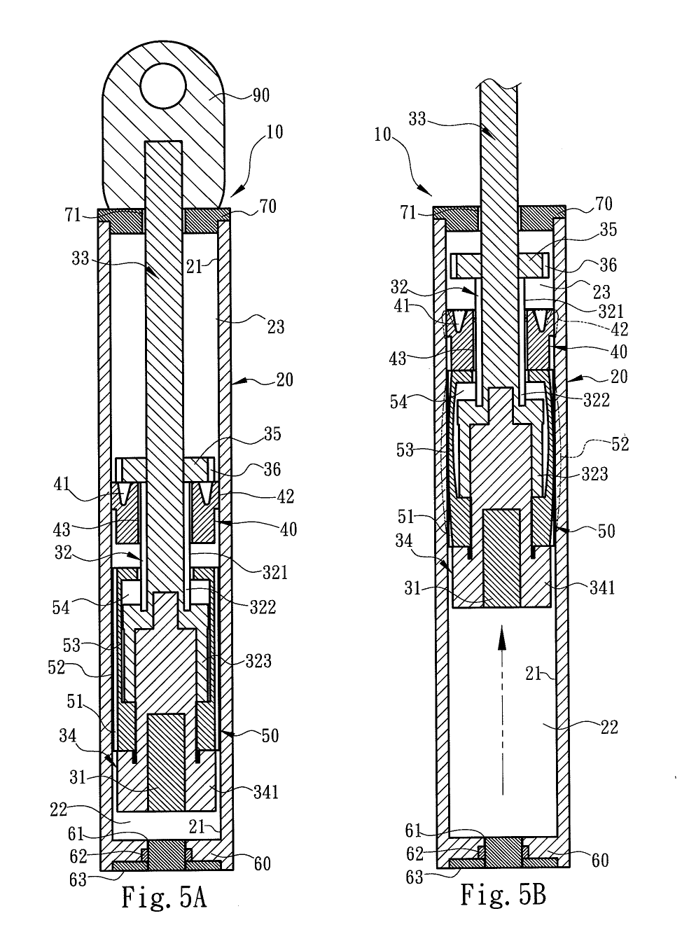

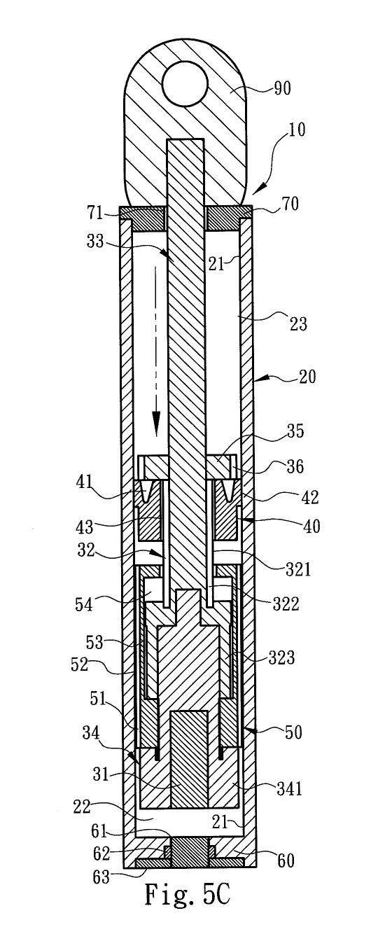

Refer to FIGS. 5A through 5C for a second embodiment of the invention in continuous operating conditions. It differs from the first embodiment by having the sub-stem 33 of the shaft 30 extended outside the tube 20 with other elements formed upside down. Moreover, the seal ring 62 of the first cap 60 does not form a close coupling with the main stem 31 since the main stem 31 is not extended outside the tube 20. By sealing the seal ring 62, the closed space 22 can be formed. In addition, the sub-stem 33 also has a distal end extended outside the tube 20 to fasten to a connector 90. When the buffer 10 is in the condition shown in FIG. 5A, the shaft 30 is moved upwards by an external pulling force, the pressure in the open space 23 pushes the outer surface 42 of the valve 40 outwards to press the inner wall 21 of the tube 20 to form a tighter coupling while the inner surface 43 of the valve 40 is slid on the stem surface 321 to squeeze the inflation member 50, and the air pressure also enters the compression zone 54 through the air intake grooves 322 to expand the inflation member 50 outwards, and the inflation member 50 is confined by the first detent element 341 and deformed to squeeze the inner wall 21 of the tube 20 to form an even tighter coupling condition as shown in FIG. 5B. Thus the valve 40 and the inflation member 50 are used to increase buffer damping for the upward moving shaft 30 to move steadily and slowly. On the other hand, referring to FIG. 5B, when the shaft 30 is moved downwards by reverse thrust, the valve 40 and inflation member 50 are quickly returned to their original shapes, the pressure in the open space 23 pushes the valve 40 downwards to aid downward moving of the shaft 30 as shown in FIG. 5C.

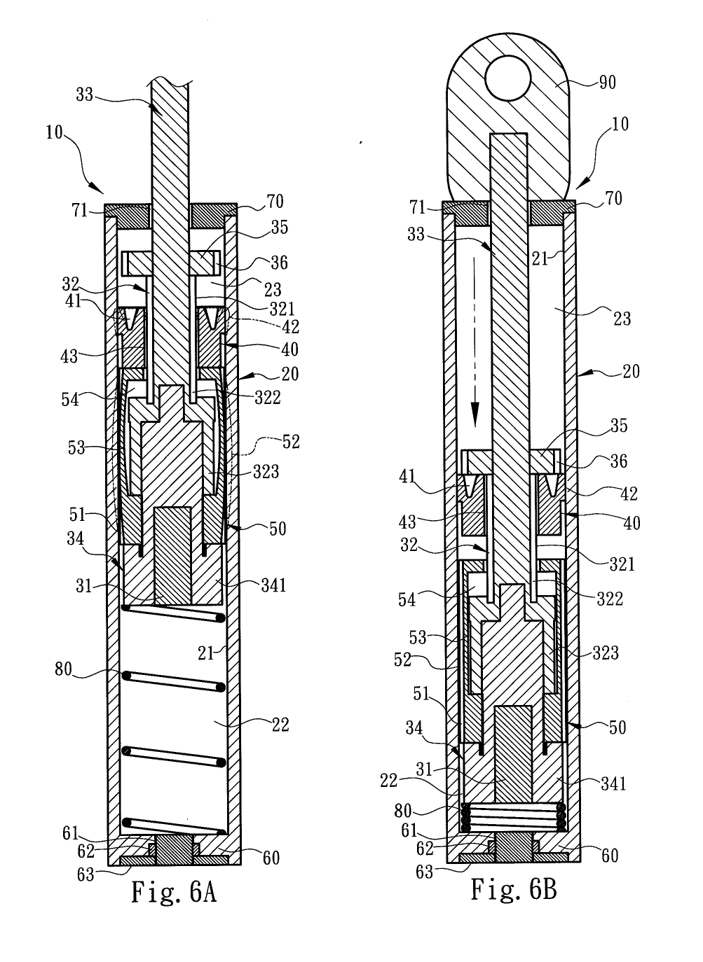

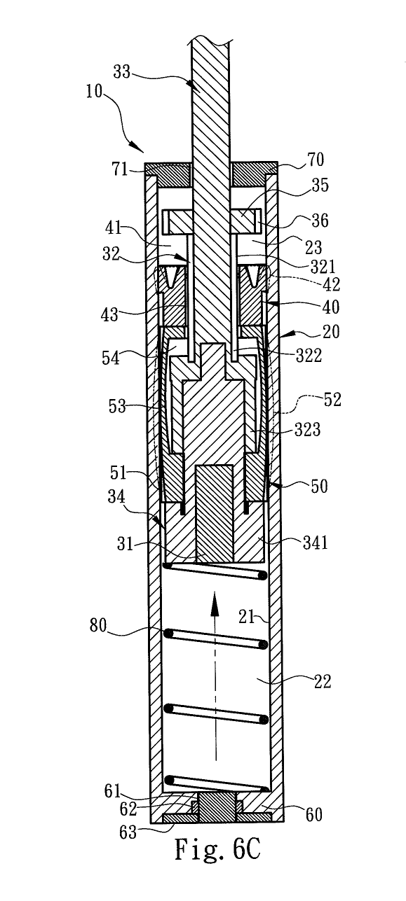

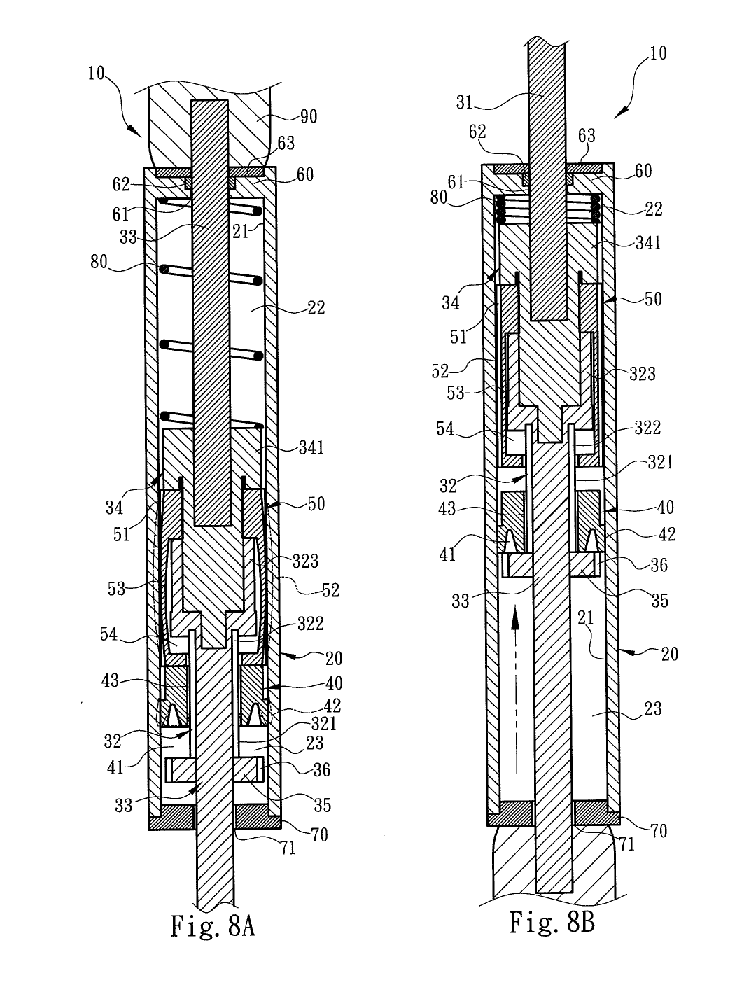

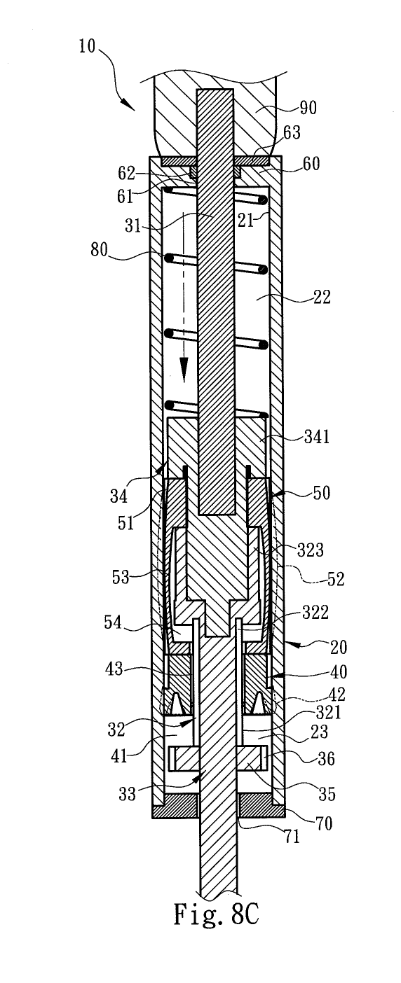

Please refer to FIGS. 6A through 6C for a variation of the second embodiment by adding a compression spring in the closed space 22. A compression spring 80 is installed in the closed space 22 between the first cap 60 and first detent element 341. When the shaft 30 is moved downwards by an external thrust as shown in FIG. 8A, the pressure of the compression spring 80 is greater than that of the open space 23, hence the downward thrust has to overcome the pressure of the compression spring 80 to make the valve 40 and inflation member 50 to return quickly to their original shapes as shown in FIG. 6B with the shaft 30 being moved downwards. On the other hand, also referring to FIG. 6B, when the shaft 30 is moved upwards by an inverse pulling force, the outer surface 42 of the valve 40 is expanded outwards to squeeze the inner wall 21 of the tube 20 to form a tighter coupling, and simultaneously compresses the inflation member 50; the air pressure also enters the compression zone 54 through the air intake grooves 322 to expand the inflation member 50 outwards, and the inflation member 50 is deformed to squeeze the inner wall 21 of the tube 20 to form an even tighter coupling condition as shown in FIG. 6C. Hence the valve 40 and the inflation member 50 are used to increase buffer damping for the upward moving shaft 30 to move steadily and slowly.

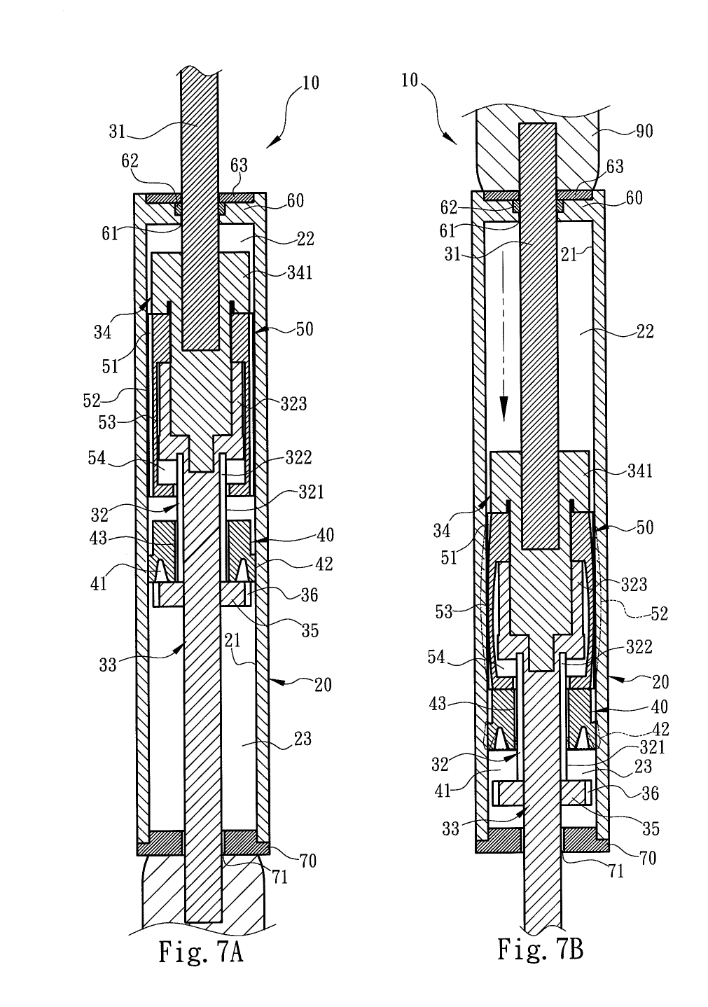

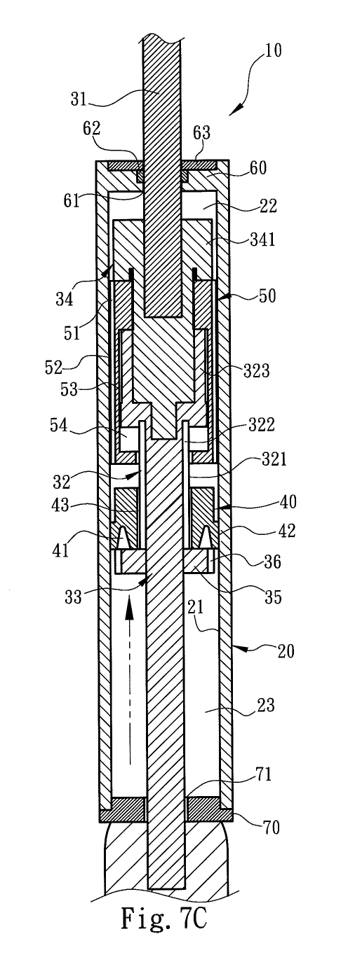

Refer to FIGS. 7A through 7C for a third embodiment of the invention in continuous operating conditions. It differs from the first embodiment by having the main stem 31 and the sub-stem 33 extended outside the tube 20 that have respectively a distal end extended outside the tube 20 to fasten to a connector 90. Its movement is substantially the same as that of the first embodiment previously discussed in FIGS. 3A through 3C, but it differs by allowing the external force to be selectively applied to the main stem 31 and/or sub-stem 33 of the shaft 30. FIGS. 8A through 8C illustrate a variation of the third embodiment by adding a compression spring 80 in the closed space 22. A compression spring 80 is installed in the closed space 22 between the first cap 60 and first detent element 341. The adopted technique and operation of the third embodiment are substantially the same as those discussed in FIGS. 4A through 4C, but it differs by allowing the external force to be selectively applied to the main stem 31 and/or sub-stem 33 of the shaft 30.

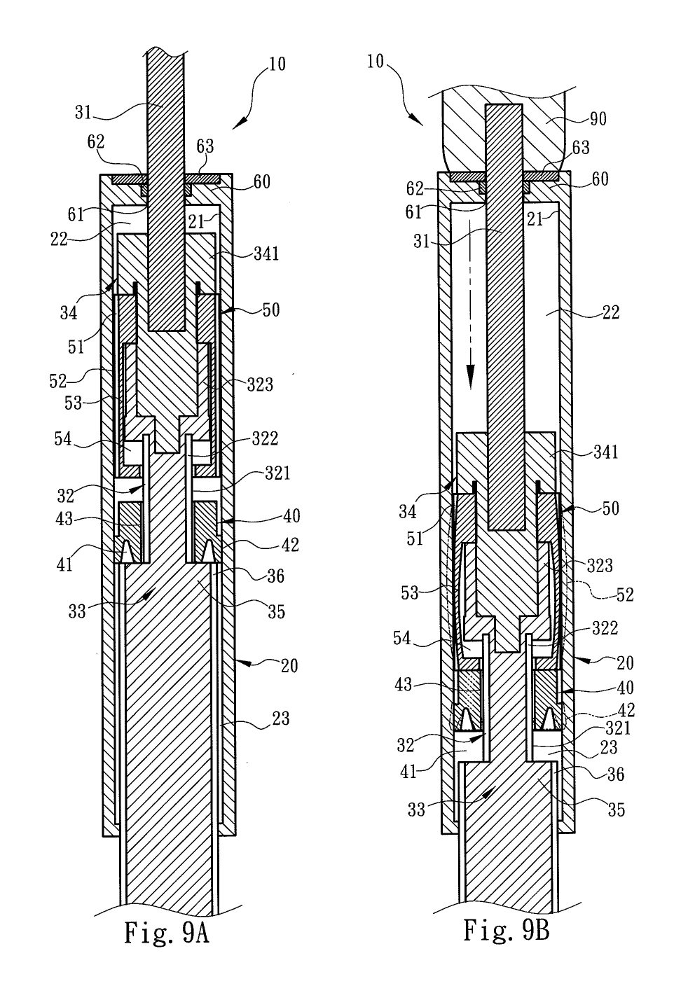

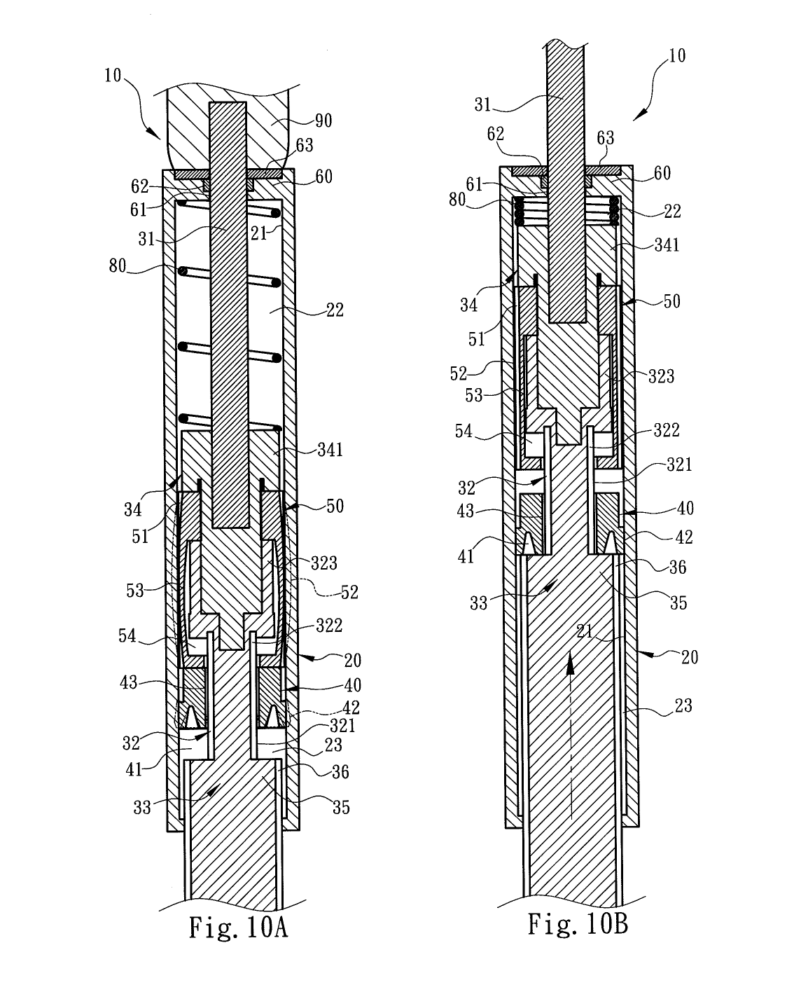

Refer to FIGS. 9A and 9B for a fourth embodiment of the invention in continuous operating conditions. Its operation is substantially the same as the third embodiment shown in FIGS. 7A and 7B, but it differs by integrating the second detent element 35 and the sub-stem 33 together without installing the second cap 70. FIGS. 10A and 10B illustrate a variation of the fourth embodiment by adding a compression spring 80 in the closed space 22. A compression spring 80 is installed in the closed space 22 between the first cap 60 and first detent element 341. The adopted technique and operation are substantially the same as those discussed in FIGS. 8A and 8B, but it differs by integrating the second detent element 35 and the sub-stem 33 together without installing the second cap 70.

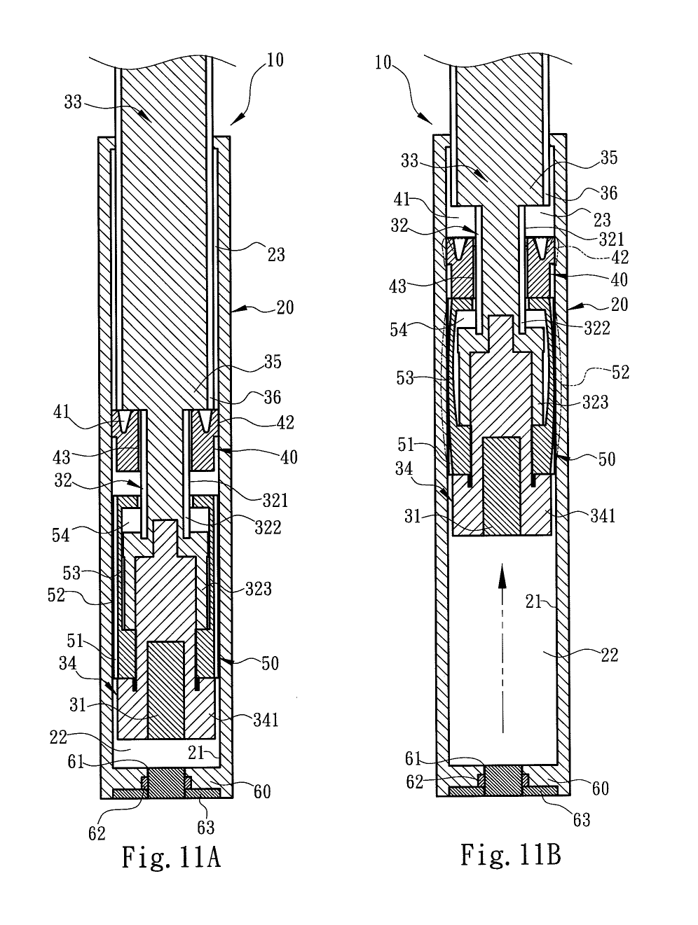

Refer to FIGS. 11A and 11B for a fifth embodiment of the invention in continuous operating conditions. Its operation is substantially the same as the second embodiment shown in FIGS. 5A and 5B, but it differs by integrating the second detent element 35 and the sub-stem 33 together without installing the second cap 70.

What is claimed is:

1. A buffer, comprising:
a hollow tube;
a first cap located at one end of the tube;
a shaft running through the tube and including a main stem, an action stem and a sub-stem, the main stem and/or the sub-stem being extended outside the tube, the main stem and the action stem being bridged by a connection bar which includes a first detent element connected to the main stem, the action stem including a coupling portion coupled with the connection bar, a stem surface including air intake grooves and a second detent element including notches;
a flexible valve which is held in the tube and surrounds the action stem in an annular manner including an outer surface in contact with an inner wall of the tube in a sliding manner and an inner surface confined to be slid on the stem surface of the action stem; the valve further including an annular recess at one side to form an open space with the tube and the action stem extended to the sub-stem, and another side facing the first cap; the outer surface of the valve forming a closed space with the tube, the action stem and the connection bar extended to the main stem and the first cap; and
a flexible inflation member held in the closed space and surrounding the coupling portion of the action stem in an annular manner, and including two ends annularly surrounding an outer surface of the connection bar and the stem surface of the action stem to form a compression zone with the action stem, and also including an outer surface in contact with the inner wall of the tube in a sliding manner, and at least one axial ventilation groove on an outer surface thereof.

2. The buffer of claim 1, wherein the tube includes another end coupled with a second cap to allow exterior of the tube to be communicated with the open space.

3. The buffer of claim 2, wherein the second cap includes an aperture to allow the exterior of the tube to be communicated with the open space.

4. The buffer of claim 3, wherein the first detent element is formed at an outer diameter smaller than that of the inflation member and greater than or equal to that of the main stem.

5. The buffer of claim 2, wherein the first detent element is formed at an outer diameter smaller than that of the inflation member and greater than or equal to that of the main stem.

6. The buffer of claim 1, wherein the first detent element is formed at an outer diameter smaller than that of the inflation member and greater than or equal to that of the main stem.

7. The buffer of claim 1, wherein the second detent element is formed at an outer diameter smaller than that of the valve and greater than or equal to that of the sub-stem.

8. The buffer of claim 2, wherein the second detent element is formed at an outer diameter smaller than that of the valve and greater than or equal to that of the sub-stem.

9. The buffer of claim 3, wherein the second detent element is formed at an outer diameter smaller than that of the valve and greater than or equal to that of the sub-stem.

10. The buffer of claim 4, wherein the second detent element is formed at an outer diameter smaller than that of the valve and greater than or equal to that of the sub-stem.

11. The buffer of claim 1, wherein the closed space holds a compression spring between the first cap and the first detent element.

12. The buffer of claim 2, wherein the closed space holds a compression spring between the first cap and the first detent element.

13. The buffer of claim 3, wherein the closed space holds a compression spring between the first cap and the first detent element.

14. The buffer of claim 4, wherein the closed space holds a compression spring between the first cap and the first detent element.

15. The buffer of claim 10, wherein the closed space holds a compression spring between the first cap and the first detent element.

16. The buffer of claim 1, wherein the first cap includes an opening surrounded by a seal ring.

17. The buffer of claim 2, wherein the first cap includes an opening surrounded by a seal ring.

18. The buffer of claim 3, wherein the first cap includes an opening surrounded by a seal ring.

19. The buffer of claim 4, wherein the first cap includes an opening surrounded by a seal ring.

20. The buffer of claim 15, wherein the first cap includes an opening surrounded by a seal ring.
